(19) United States
(12) Patent Application Publication
(10) Pub. No.: US 2004/0191452 A1
(43) Pub. Date: Sep. 30, 2004

(54) Multilayered, electrically conductive line

(75) Inventors: Tevfik Severengiz, Gelnhausen (DE); Joachim Jaborek, Wiesen (DE)

Correspondence Address: BURNS DOANE SWECKER & MATHIS L L P, POST OFFICE BOX 1404, ALEXANDRIA, VA, 22313-1404, US

(73) Assignee: VERITAS AG, Gelnhausen (DE)

(21) Appl. No.: 10/767,948

(22) Filed: Jan. 30, 2004

(30) Foreign Application Priority Data
Mar. 24, 2003 (DE) 103 12 942.1

(51) Int. Cl. B32B 1/08

(52) U.S. Cl. 428/36.91

(57) ABSTRACT

A multilayered, electrically conductive line comprising at least one carrier layer and a barrier layer arranged within said carrier layer and including at least one electrically conductive section which extends at least in portions in the longitudinal direction of the line. According to the invention, to manufacture such lines in an easier way while ensuring adequate barrier effect and electrical properties at the same time, the electrically conductive section is arranged within the barrier layer.

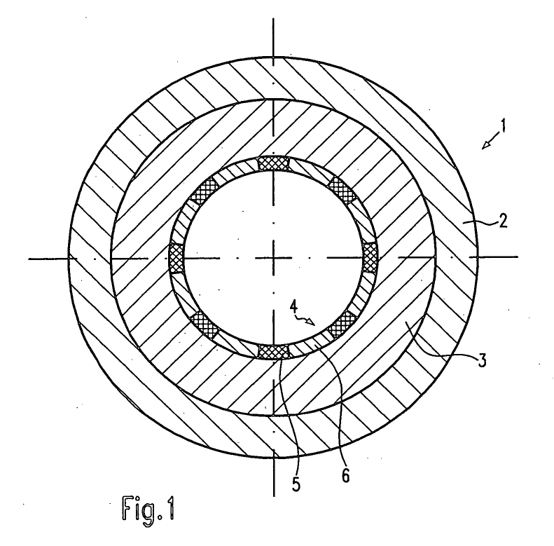

The present invention relates to a multilayered, electrically conductive line comprising at least one carrier layer and a barrier layer arranged within said carrier layer and including at least one electrically conductive section which extends at least in portions in the longitudinal direction of the line.

Such a line is e.g. known from DE 198 54 819. The lines described therein are used in the car industry as fuel lines and are often designated as so-called antistatic conductive lines. The line is of a multilayered structure with an outer carrier layer of plastics and a barrier layer of fluorine-containing substances that is positioned with the carrier layer. An electrically conductive layer of a plastic material is provided as the innermost layer and contains carbon particles. The barrier layer is to prevent a diffusion of gases or transported fuel through the line. The electric charge produced during transportation of fuels is to be discharged through the electrically conductive layer. Ignition of the fuel by electric charge is thereby to be prevented. However, it has been found that the mechanical properties are not always satisfactory. To be more specific, flexibility and mechanical stability of the lines are reduced by the electrically conductive inner layer.

Moreover, DE 101 17 753 discloses a flexible tube with conductive strips, wherein the strips are arranged on the inside of the flexible tube and electrically insulated by the surrounding material.

It is therefore the object of the present invention to improve the known antistatic lines and to overcome the drawbacks of the prior art in such a way that the mechanical properties are improved and the static electricity can be discharged in an improved way.

According to the invention this object is achieved by a multilayered, electrically conductive section of the above-mentioned type, wherein an electrically conductive section is arranged within the barrier layer and extends radially over the whole wall thickness of the barrier layer.

This solution is simple and has the advantage that, instead of a barrier layer and an additional antistatic conductive layer adjacent thereto in radial direction, only one layer is now required that can assume both the barrier function and the function of electrical conductivity. It has been found that with this design an adequate barrier effect with a simultaneously improved flexibility of the line can be ensured. The electrically conductive section gets into direct contact with the fluid to be transported, e.g. a fuel, and can directly discharge the charge arising. Moreover, the electrically conductive section can thereby be optimized in terms of volume in the circumferential direction of the barrier layer. With a given cross-sectional area, the electrically conductive section can thus be made as small as possible by exploiting the maximum radial extension of the barrier layer. Since the conductive section can directly rest on the carrier layer, it is also possible to discharge electric charge radially via the carrier layer if said layer is also conductive. Moreover, the barrier layer can be produced simultaneously with the antistatic conductive section so that the number of work steps is reduced and the product quality can be enhanced.

In an advantageous development, the line may be formed as a flexible tube. Especially with flexible tubes, improved flexibility characteristics are of advantage.

It may be of advantage when the electrically conductive section is substantially strip-like.

Moreover, it may turn out to be advantageous when a plurality of spaced-apart electrically conductive sections are provided in circumferential direction of the barrier layer. The conductive characteristics can thus be realized as uniformly as possible over the circumference of the barrier layer.

It may turn out to be advantageous when insulating barrier sections of the barrier layer are also substantially strip-shaped, with electrically conductive sections and insulating barrier sections alternating with one another.

Moreover, it may also turn out to be advantageous when the barrier layer forms the inner layer with the electrically conductive section. The barrier layer can thus be used together with the electrically conductive section as efficiently as possible.

Moreover, it may be of advantage when the conductive sections are segment-like when viewed in cross section. The effect of the conductive sections can be optimized with such a design.

It may also turn out to be advantageous when the volume amount of the conductive sections in the total volume of the inner layer is smaller than the volume amount of the insulating barrier sections.

It may be of advantage when the volume amount of the conductive sections is less than 25%, preferably 1-5%.

In an advantageous development of the invention, the electrically conductive section may contain carbon. For instance, soot may be added to the electrically conductive section to obtain the electrically conductive properties in an inexpensive and efficient way.

To improve the strength of the barrier layer with the electrically conductive section, the basic material of the electrically conductive section may be the same as the basic material of the barrier layer. A continuous barrier layer with conductive, antistatic, segment-like sections can thereby be realized.

In an advantageous development of the invention, the barrier layer may contain fluoromaterials. Particularly advantageous barrier effects against the diffusion of hydrocarbons can be achieved with substances containing such fluoromaterials. The use of tetrafluoroethylene hexafluoropropylene vinylfluoride (THV), or alternatively, polyvinylidenefluoride (PVDF), ethylene-tetrafluoroethylene copolymer (ETFE) or polytetrafluoroethylene (PTFE) may here turn out to be of advantage.

In an advantageous development of the invention, the carrier layer contains polyamide-6, -11, -12, -6.6, and others, or polyolefin. Preferred polyolefins are polyethylene and polypropylene. In this instance the carrier layer may also be made antistatic.

Fuel-resistant thermoplastic elastomers (TPE) or thermoplastically cross-linked elastomers may be used for the carrier layer. For instance, acrylnitril-butadiene rubber (NBR) or ethylene acrylate rubber (AEM) or polychlorobutadiene (CR) or chlorinated polyethylene (CM) or also ethylene-oxide epichlorohydrine rubber (ECO) may be used. It is also possible to produce the carrier layer with polyvinylchloride (PVC). Flexible tubes can be realized with said materials at low costs.

The carrier layer may also be electrically conductive in an advantageous way. To this end the carrier layer may contain carbon. The static electricity can thereby be discharged over the whole cross-section of the flexible tube.

Moreover, the invention refers to a method for producing a pipe according to the invention, wherein the insulating barrier layer is simultaneously extruded with the electrically conductive section.

In comparison with conventional solutions, wherein an electrically conductive layer is first extruded and then a barrier layer and in a successive step the carrier layer, the manufacturing process can be considerably reduced in time by the solution of the invention.

The invention will now be explained in more detail with reference to an embodiment.

The sole drawing shows a cross section through a line according to the invention.

The line is marked with reference numeral 1. This is a flexible line and, therefore, it can also be designated as a flexible tube or a plastic tube. The line 1 is constructed as a multilayered tube with an outer layer 2, a carrier layer 3 and an inner layer 4 which simultaneously forms the barrier layer and the electrically conductive section. To realize such a configuration, the inner layer 4 is strip-shaped with electrically conductive antistatic sections or segments 5 and barrier sections 6. The electrically conductive segment-like sections 5 alternate with insulating barrier sections 6. The radial extension of the electrically conductive sections 5 is here as large as the radial extension of the barrier layers, thereby extending over the whole wall thickness of the barrier layer or inner layer 4. There is also provided an equal number of electrically conductive sections and barrier sections, the volume amount of electrically conductive sections being considerably smaller than that of the barrier sections on the inner layer 4 or barrier layer 5. In the present embodiment, the volume amount of the antistatic sections is about 25% of the inner layer, preferably 1-5%. The number of barrier sections and conductive sections is given by way of example in the various embodiments. It is also possible to provide a larger or smaller number of barrier sections and electrically conductive sections. On account of the strip-like design, the insulating barrier sections 6 and electrically conductive sections 5 extend in the longitudinal direction of the pipe or tube. A spiral extension of the barrier sections and electrically conductive sections is also possible.

In the present embodiment, elastomers are used for the outer layer 2 and the carrier layer 3, for instance ethylene-oxide epichlorohydrine rubber (ECO) or alternatively acrylnitril-butadiene rubber (NBR) or ethylene-acrylate rubber (AEM). It is also possible that an outer layer 2 is absent and that the pipe is only of a two-layered construction. Likewise, it is possible to provide several layers and to dispose a reinforcement layer of a fabric or the like, for instance, between the outer layer 2 and the carrier layer 3. The inner layer consists of a uniform polymer, e.g. fluoropolymer, polyamide, polyethylene, or other fuel-resistant polymers, and in the area of the barrier sections the polymer fluoromaterials and in the area of the electrically conductive sections carbon is additionally provided next to fluoromaterials. The barrier effects are produced by the fluoromaterials in that a diffusion of carbons through the line is prevented. Since the fluoromaterials are present over the whole circumference of the inner layer, a barrier effect is produced over the whole circumference of the inner layer. The carbon may e.g. be added in the form of soot to achieve the electrically conductive properties. Alternatively, it is possible to add metal chips, metal powder, nanoparticles, or carbon fibrils.

Alternatively, it is also possible to produce the electrically conductive sections and the barrier sections from different basic materials. These, however, must be chosen such that an adhesion of the electrically conductive sections to the barrier sections is ensured. Polyvinylidenefluoride (PVDF) or tetrafluoroethylene hexafluoropropylene vinylfluoride (THV) or ethylene tetrafluoroethylene copolymer (ETFE) or polytetrafluoroethylene (PTFE) are e.g. suited for the barrier sections. Soot-blended polymers, polyamides or polyolefins are suited for the electrically conductive sections. As a rule, however, the same basic material should be used for the electrically conductive sections and the barrier sections for reasons of strength. Although a different basic material may alternatively be used, the same basic material has turned out to be of advantage.

To produce the pipe according to the invention, the inner layer 4 or barrier layer may first be produced, the electrically conductive sections and the barrier sections being extruded at the same time. A barrier layer can thereby be produced that exhibits electrically conductive properties at the same time.

Operation and function of the invention will now be explained in more detail.

The preferred embodiment of the line or flexible tube according to the invention is used as a fuel line. Increasing environmental demands require improved diffusion resistance to hydrocarbons. Moreover, electric charges arising during fuel transportation must be discharged. With the pipe or tube of the invention it is now possible to meet both demands with only one barrier layer. The electrically conductive sections are in direct contact with the fuel to be transported so as to discharge directly arising electric charge. Thanks to the design of the electrically conductive sections over the whole wall thickness of the barrier layer or inner layer 4, the electrically conductive sections 5 are also directly adjacent to the carrier layer 3 surrounding said sections. The materials of the outer layer 2 or carrier layer 3 are also electrically conductive within a range of 10³-10⁷ Ω/cm (volume resistance). The surface resistance of the outer layer 2, which forms a cover layer, is within a range of 10³-10⁷ Ω. Resulting electric charge can thus be discharged directly radially over the whole wall thickness of the flexible tube.

The barrier sections which comprise fluoromaterials, as well as the conductive sections, reliably prevent a diffusion of hydrocarbons. Thanks to the uniform distribution of electrically conductive sections and barrier sections, it has been found that a diffusion of hydrocarbons can be efficiently prevented and excellent electrical conduction properties can be achieved at the same time. Due to the strip-like design of the electrically conductive sections and the barrier sections, it has also been found that mechanical stability and flexibility are improved in comparison with conventional flexible tubes or pipes in which the inner layer is formed by an electrically conductive inner layer and a barrier layer disposed adjacent thereto. Moreover, flexible tubes of the invention have turned out to be cold-flexible and temperature-resistant and can be operated within a range of −40° C. to 125° C.

1. A multilayered, electrically conductive line comprising at least one carrier layer and a barrier layer arranged within said carrier layer, and at least one electrically conductive section which extends at least in portions in the longitudinal direction of said line, wherein said electrically conductive section is arranged within said barrier layer and extends radially over the whole wall thickness of said barrier layer.

2. The multilayered, electrically conductive line according to claim 1, wherein the pipe is designed as a flexible tube.

3. The multilayered, electrically conductive line according to claim 1, wherein said electrically conductive section is substantially strip-like.

4. The multilayered, electrically conductive line according to claim 1, wherein said conductive sections are segment-like when viewed in cross section.

5. The multilayered, electrically conductive line according to claim 1, wherein a plurality of spaced-apart electrically conductive sections are provided in circumferential direction of said barrier layer.

6. The multilayered, electrically conductive line according to claim 1, wherein said barrier layer is substantially strip-shaped, with electrically conductive sections and barrier sections alternating with one another.

7. The multilayered, electrically conductive line according to claim 1, wherein said barrier layer with the electrically conductive section forms said inner layer.

8. The multilayered, electrically conductive line according to claim 1, wherein the volume amount of said conductive sections in the total volume of said inner layer is smaller than the volume amount of said barrier sections.

9. The multilayered, electrically conductive line according to claim 1, wherein said volume amount of said conductive sections is less than 25%, preferably 1-5%.

10. The multilayered, electrically conductive line according to claim 1, wherein said electrically conductive section contains carbon.

11. The multilayered, electrically conductive line according to claim 1, wherein said electrically conductive section contains metal chips.

12. The multilayered, electrically conductive line according to claim 1, wherein the basic material of said conductive section is equal to the basic material of said barrier layer.

13. The multilayered, electrically conductive line according to claim 1, wherein said barrier layer contains fluoromaterials.

14. The multilayered, electrically conductive line according to claim 1, wherein said barrier layer contains tetrafluoroethylene hexafluoropropylene vinylfluoride (THV).

15. The multilayered, electrically conductive line according to claim 1, wherein said barrier layer contains polyvinylidenefluoride (PVDF).

16. The multilayered, electrically conductive line according to claim 1, wherein said basic material of said barrier layer or of said electrically conductive sections contains a polyamide or polyolefin.

17. The multilayered, electrically conductive line according to claim 1, wherein said carrier layer is electrically conductive.

18. The multilayered, electrically conductive line according to claim 1, wherein said carrier layer contains a polymer.

19. The multilayered, electrically conductive line according to claim 1, wherein said carrier layer contains carbon.

20. The multilayered, electrically conductive line according to claim 1, wherein said carrier layer contains polyvinylchloride (PVC).

21. The multilayered, electrically conductive line according to claim 1, wherein said carrier layer contains a thermoplastic elastomer (TPE).

22. The multilayered, electrically conductive line according to claim 1, wherein said elastomer is selected from acrylnitril-butadiene rubber (NBR), ethylene acrylate rubber (AEM), polychlorobutadiene (CR), chloropolyethylene (CM), or ethylene-oxide epichlorohydrine rubber (ECO).

23. A method for producing a multilayered, electrically conductive pipe according to claim 1, wherein said barrier layer is simultaneously extruded with said electrically conductive section.
